(19) United States
(12) Patent Application Publication
(10) Pub. No.: US 2007/0219844 A1
(43) Pub. Date: Sep. 20, 2007

(54) Event scheduling system

(76) Inventors: Adolph W. Santorine JR., Bridgeport, OH (US); Timothy L. Weaver, Bellaire, OH (US)

Correspondence Address: THE WEBB LAW FIRM, P.C., 700 KOPPERS BUILDING, 436 SEVENTH AVENUE, PITTSBURGH, PA, 15219, US

(21) Appl. No.: 11/725,321

(22) Filed: Mar. 19, 2007

Related U.S. Application Data
(60) Provisional application No. 60/783,257, filed on Mar. 17, 2006.

(51) Int. Cl. G06F 15/02

(52) U.S. Cl. 705/9

(57) ABSTRACT

A system and method directed to the automatic scheduling of sports events. Once a master event is entered, at least one dependent event is automatically created. The event is a dependent event because for scheduling, it depends upon scheduling information of the master event. The method further includes scheduling the master event for a facility and indicating those dependent events which are to be scheduled at the facility and other facilities for a scheduled date. The scheduler system comprising a database for storing athletic events information, an events scheduler capable of electronically receiving new events, or event definition that associates a particular athletic event with at least a parent event.

### CROSS REFERENCE TO RELATED APPLICATIONS

This application is based on Provisional Patent Application No. 60/783,257, filed Mar. 17, 2006, on which priority of this patent application is based, and which is hereby incorporated by reference in its entirety.

### BACKGROUND OF THE INVENTION

1. Field of the Invention

The present invention relates generally to event scheduling (for example, for athletic competitions) using computer networks and, more specifically, to providing automated scheduling of related athletic contests based on rules programmed into the system by users.

2. Technical Considerations

Athletic scheduling programs are designed to allow athletic departments the capability to enter schedule information into a central system, which can then be used throughout the organization in many different capacities. In other words, a “schedule once, use everywhere system” efficiently utilizes and revises data from the initial entry to revising data such as team information, referee information and scheduling information, allowing Athletic Directors to save time compared to traditional manual scheduling. Scheduling software allows athletic departments to store in one place their schedules, scores and activities, allowing organizations that rely on automatic systems of schedules to benefit from quick and accurate dissemination of information to members of their staff, student body and community.

Athletic departments must organize and provide timely and accurate information to all of the support personnel that make a high school athletic event possible. The athletic department relies on the tools provided by the system to flow smoothly through screens and business processes in a challenging environment. Moreover, in the past, the overall process of adjusting schedules became a balancing act as events were certain to conflict due to lack of standards and controls.

While the use of features in an athletic scheduling system makes management easier, the amount of information to be managed continues to grow. For example, athletic events can include tourneys (tournaments), home games and away games, different teams and opponents every week, the tracking of each and every event, reporting of each and every event to a variety of printers and files, contracts, notes and customizations. To manually enter just one event becomes a very difficult task.

### SUMMARY OF THE INVENTION

The present invention is directed to a system and method for the automatic scheduling of events. The main method of the invention describes the steps to schedule athletic events for a plurality of facilities. Once a master event is entered, at least one dependent event is created by assigning an event to a master event; the event is a dependent event because for scheduling it depends upon scheduling information of the master event. The assignment of the dependent to the master is adapted to rules for specific restrictions. The scheduling of the event includes scheduling the master event for a facility. The method can include a function indicating those dependent events which are to be scheduled at the facility and other facilities for a scheduled date. The scheduling of the dependent events is completed by saving data fields describing the schedule. A user can view the schedule on a screen transmitted to the user showing the events scheduled for a particular date.

The method of the present invention can further include at least one team is created comprising participants defined in the system. An event is entered into the system, assigning transportation, mirroring an event for any number of years for scheduling in subsequent years of a series of events, postponing an event either by delaying or canceling, assigning officials for an event, printing a requisition request for transportation, checking eligibility of participants, printing an event contract, printing an event schedule and printing participant certificates.

The method can create a database comprising data records for dependent events and master events. The data records can include a value that links the records together making one a master and the other a dependent event. One possible field can be a reference. Primarily, events have characteristic information which modifies the record and facilitates references. The information can include gender, level and sport for matching dependent to master, home facility, start time, end time, dismiss time, transportation or away facility. Teams can be comprised of a coach, an assistant coach, a manager or a player.

The rules for a dependent event include constraints on when and where a game can be played. They inform the scheduler when and where to schedule the dependent events. Examples of rules include to schedule the dependent event when the master is home, schedule the dependent event when the master is away, schedule the dependent event when the master is home or away, schedule the dependent event home when the master event is away, schedule the dependent event away when the master event is home and schedule the event time and day.

The method can further include a transmitted view of a schedule. The schedule can be in the form of a calendar communicated as a generated link to an interactive web page or an electronic mail message for viewing events scheduled, including a calendar. The calendar may incorporate searchable dates in any form, for example, selectable date fields on a calendar returning items scheduled thereon.

The present invention further includes an automated events scheduling system. The system may incorporate a database for storing athletic events information and at least one event definition that associates a particular athletic event with at least one parent event. The system can incorporate an events scheduler capable of electronically receiving new event information submitted by a user, producing a plurality of athletic interactive web pages using event information contained in said database, and automatically, electronically transmitting said athletic interactive web pages to users associated with said athletic events as determined by said database. The events scheduler may further act to access the database and the contents therein. At least one processing device is associated with a user and operably coupled to said events scheduler via an electronic network for transmitting and receiving an electronic message, including said new athletic event information and said athletic interactive web pages. The system may, instead, have a plurality of personal computing devices or users operably coupled via an electronic network for transmitting and receiving electronic messages, including said new athletic event information and said athletic interactive web pages.

Said events scheduler automatically transmitting said new event athletic interactive web pages to a plurality of event addresses comprising users associated with said organization associated with said new event as determined by said database. The events scheduler producing and transmitting user requested athletic interactive web pages to personal computing devices using an electronic network in response to a user request received via said personal computing device.

### BRIEF DESCRIPTION OF THE DRAWINGS

FIG. 1 is a functional block diagram of a preferred embodiment of a system according to the present invention;

FIG. 2 is a description of information contained in an athletic events database according to the present invention;

FIG. 3a is a flowchart showing the steps for creating events;

FIG. 3b is a preferred embodiment of an interactive web page for entering a scheduled event;

FIG. 4 is a preferred embodiment of an interactive web page for listing scheduled events;

FIG. 5 is a preferred embodiment of an interactive web page for scheduling dependent events;

FIG. 6 is a preferred embodiment of an interactive web page for scheduling master events;

FIG. 7a is a flowchart showing an event scheduling method according of the present invention;

FIG. 7b is a flowchart showing an event defining method according of the present invention;

FIG. 8 is a flowchart showing steps for scheduling a dependent event; and

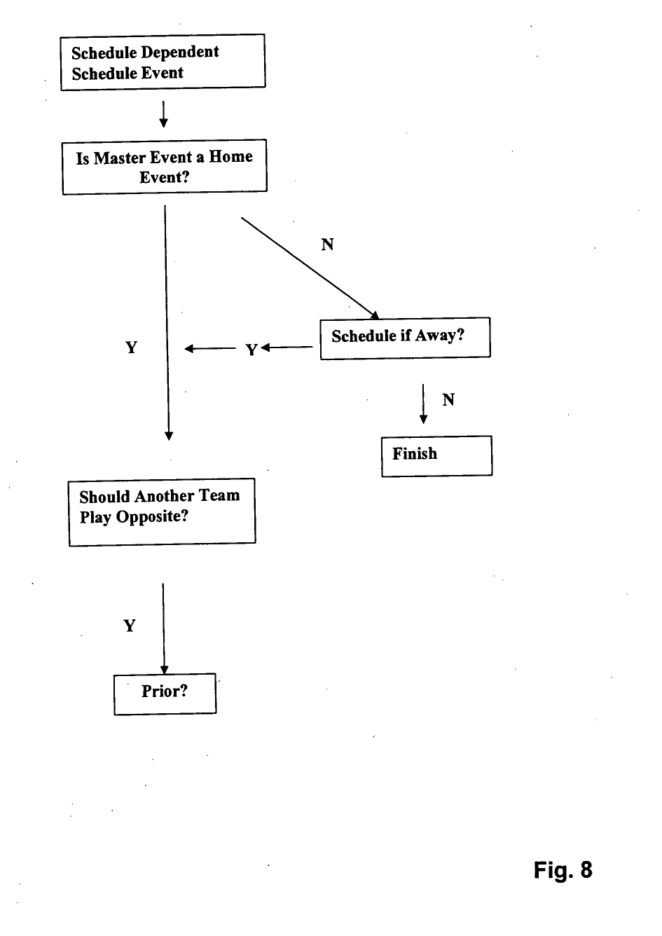

FIG. 9 is a preferred embodiment of an interactive web page for viewing scheduled events.

### DETAILED DESCRIPTION OF THE PREFERRED EMBODIMENTS

The present invention comprises a system and method for the automated management and dissemination of event scheduling information.

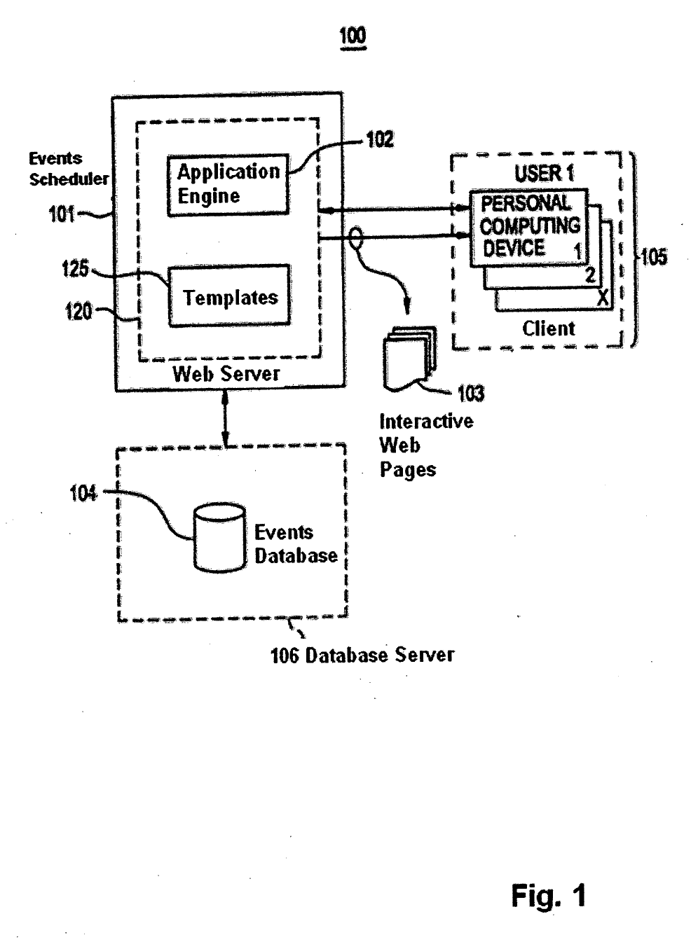

In a preferred embodiment, an event scheduling system 100 comprises an events scheduler 101, athletic interactive web pages 103, a database server 106, and a personal computing system 105 as shown in FIG. 1. Event scheduling system 100 can be implemented in accordance with the three tier architecture as shown in FIG. 1 for serving worldwide web pages over an electronic network, such as the Internet. Client users interact with event scheduling system 100 using web browser enabled personal computing device 105.

Personal computing device 105 can be a personal computer (PC) running a web browser application, such as, but not limited to, Microsoft Internet Explorer™. However, personal computing device 105 may be any browser enabled device, such as a personal organizer, personal computing device 105 and events scheduler 101 communicating by transmitting and receiving electronic packets over an electronic network, such as the Internet, in accordance with the Hypertext Transport Protocol (HTTP).

Referring again to FIG. 1, events scheduler 101 includes a web server 120, an application engine 102 and templates 125. Events scheduler 101 includes business logic required to effect the operation of event scheduling system 100 as described herein.

Web server 120 receives electronic packets from personal computing devices 105 and transmits to the personal computing devices 105 web pages containing information pertaining to the scheduling of athletic events. Server 120 can be implemented using the Internet Information Server (IIS) web server application, Apache, Netscape, Enterprise or iPlanet. However, other servers can be utilized as the type of server is not meant to be limiting.

Templates 125 include: (1) templates 125 to extract information from HyperText Markup Language (HTML) forms received via events scheduler 101 from users via personal computing devices 105, and (2) templates 125 to generate web pages comprising athletic interactive web pages 103 containing content retrieved from athletic events database 104 to be transmitted by events scheduler 101 to users via personal computing devices 105.

Application engine 102 can be implemented as a cold fusion application server environment. In alternative embodiments, application engine 102 can be implemented using another language, such as, but not limited to, Active Server Pages (ASP), Java, C++, JavaScript™, PERL or Visual Basic Script (VBSCRIPT). Application engine 102 and templates 125 provide means for events scheduler 101 to access information contained in athletic events database 104.

Database server 106 comprises an athletic events database 104 that stores and retrieves information as directed by application engine 102. Application engine 102 executes the programmed instructions contained in one or more templates 125. Templates 125 are maintained in non-volatile storage at web server 120. Alternatively, templates 125 are maintained in non-volatile storage at database server 106. Generally, templates 125 can be maintained using any local or remote non-volatile storage means accessible to events scheduler 101. Templates 125 executed by application engine 102 thereby control the storage and retrieval of information contained in athletic events database 104.

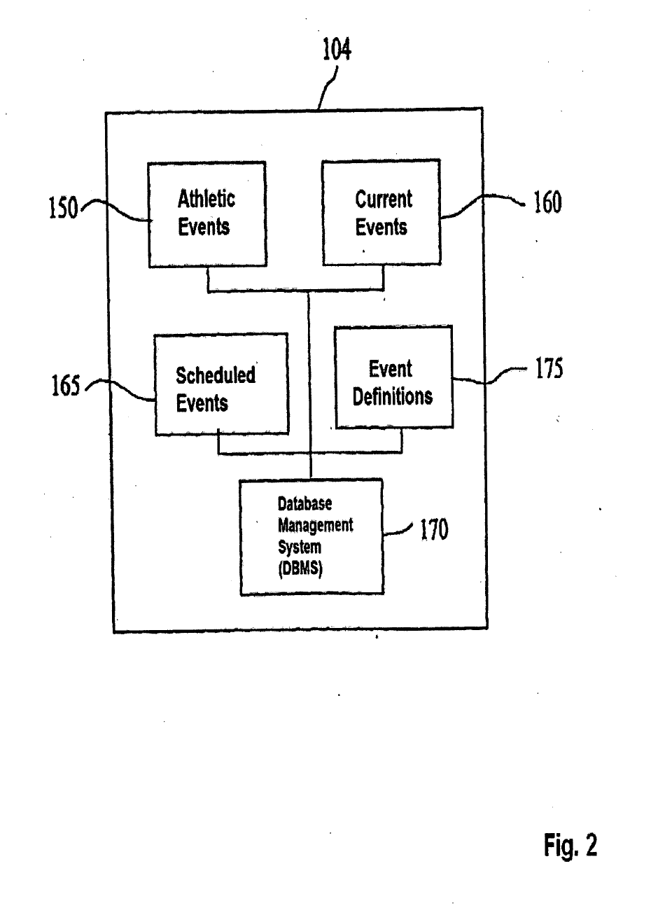

Illustrated in FIG. 2, athletic events database 104 includes data fields for athletic events 150, current events 160, scheduled events 165, and event definitions 175. Information contained in athletic events database 104 can be indexed, sorted, or accessed by a variety of attributes, including, but not limited to, the team name, sport, date and time of the organization with which the information recorded is associated. Although athletic events are described, this invention is not limited to only athletic events, as the invention can be used to schedule other types of events such as musical programs, debate programs, drama or moot court.

Athletic interactive web pages 103 are generated by events scheduler 101 and transmitted to a personal computing device 105 by events scheduler 101. To generate an athletic interactive web page 103, events scheduler 101 accesses athletic events 150, current events 160, scheduled events 165, and event definitions 175 of the athletic events database 104 by transmitting requests to application engine 102 and receiving responses and data from application engine 102. Scheduler 101 requests are provided in the form of commands and messages making it possible to access data from Database Management System (DBMS) 170.

An athletic event 150 describes various specific aspects of athletic events including, but not limited to, a high school sporting events. Athletic event 150 information fields can include, but are not limited to, the date, time, team, gender, level, sport and opponent.

An event definition 175 is a number of data fields for describing various athletic aspects of a particular team type. Event definition 175 information fields include, but are not limited to, the gender of the team, class level, sport, home facility, start time for home games, end time for home games, dismiss time for home games, transportation for home games, away facility, start time for away games, end time for away games, dismiss time for away games and transportation for away games. Events definition also stores data fields for determining whether an additional game for another team is to be scheduled in correspondence to the particular event.

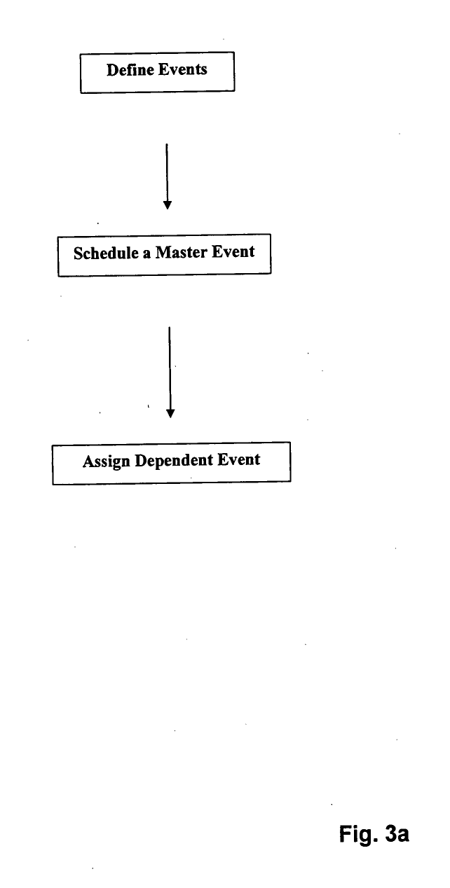

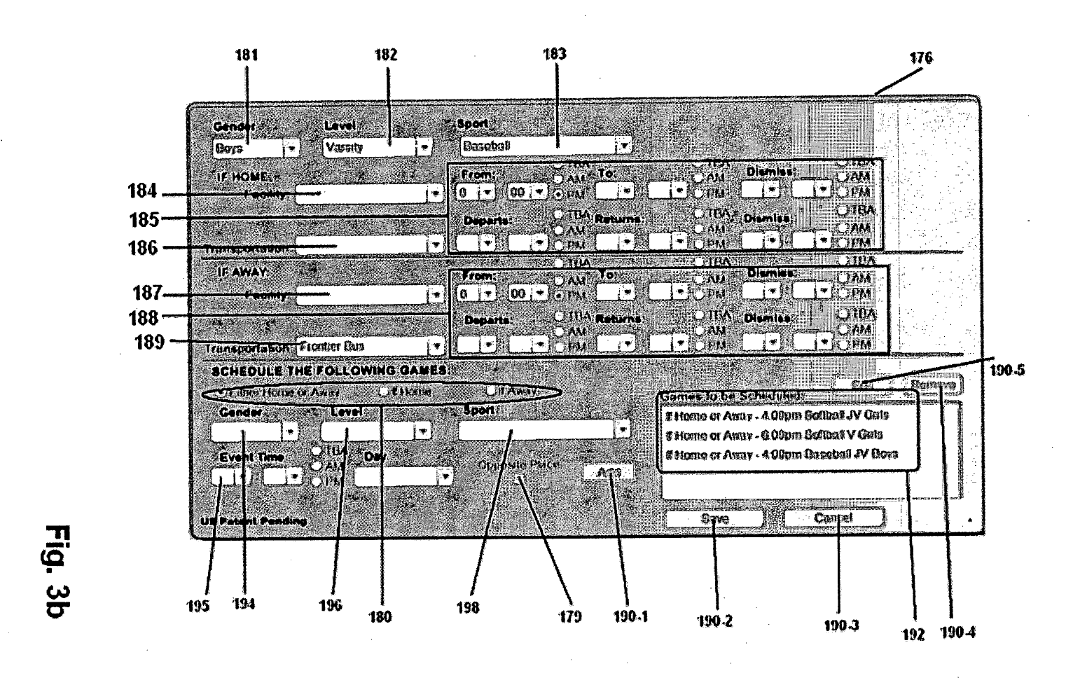

In the method of the present invention, all events must be entered into the system with reference to FIG. 3a, steps of the present invention are shown. In step 1, the user of the present invention, defines events, this includes all sub-events. Next, in step 2, master events are defined and entered into the system. In step 3, the events are utilized by the present invention to create a schedule. Events are definitions of scheduled items; once an event is created, one can create schedules by forming scheduled events. A scheduled event is a specific instance of an event definition.

An interactive web page useful for entering an event definition is shown in FIG. 3b. The system creates an interactive web page in order to generate the events definition web page. A web page request is received from the client's personal computing device 105 at the message events scheduler 101 that then requests application engine 102 to execute the appropriate template to generate the requested interactive web page 103 such as event definition page from the information contained in athletic events database 104. The interactive web page 103 thus generated is then transmitted by events scheduler 101 to the requesting client's personal computing device 105. Personal computing device 105 then displays the interactive web page 103 via web browser or some other viewer.

Events scheduler 101 prompts the user for defining events in correspondence to the defined game as shown in the event definition page of FIG. 3a. Users can indicate to events scheduler 101 their preference that, 1) when the defined master team plays a home game, another team should be scheduled to play a prior home game, or 2) after the master event, another team should play a home game. In FIG. 3b, users can indicate their preference to event scheduler 101 by checking an interactive field indicating one of “home”, “away” or “either” in the home and away schedule buttons 180. Events scheduler 101 then transmits the event definition 175 to the athletic events database 104.

In addition, events scheduler 101 has the capability to determine when the defined team plays a home game, and schedule another team to play an away game prior to or after the master event. Again, events scheduler 101 would determine the user's preference by checking the contents of a opposite place field 179 of the events definition 175. The opposite place 179 interactive checkbox of FIG. 3b, which corresponds to an event definition 175 field of the same name could be used to transmit that information to event scheduler 101. Finally, it is also possible that the user will schedule the defined team to play an away game and another team should be scheduled to play an away game prior to the master event or after the master event.

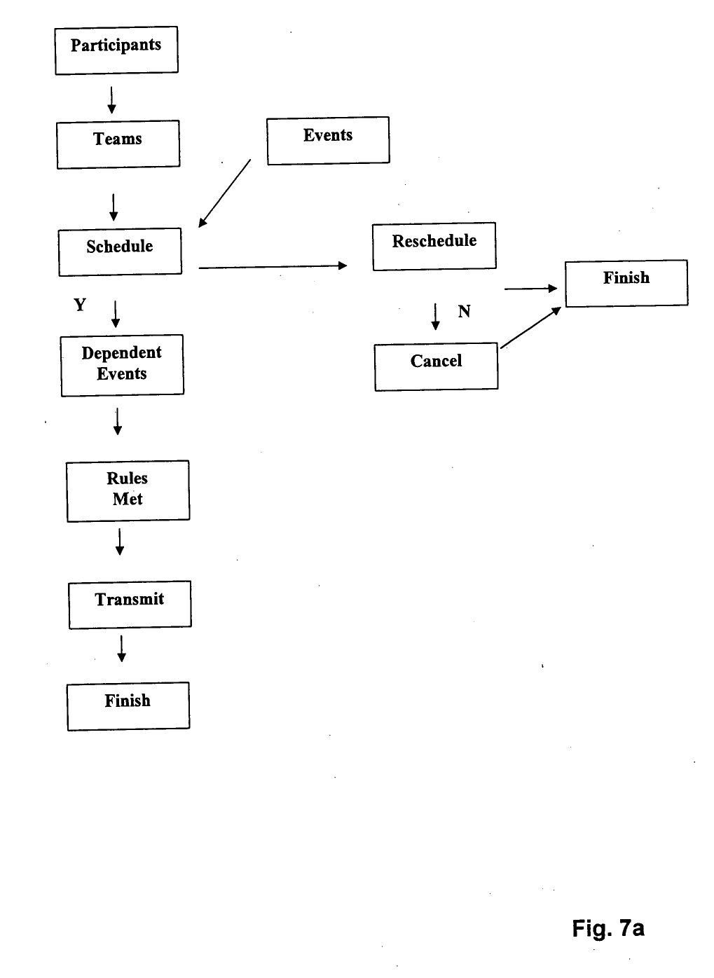

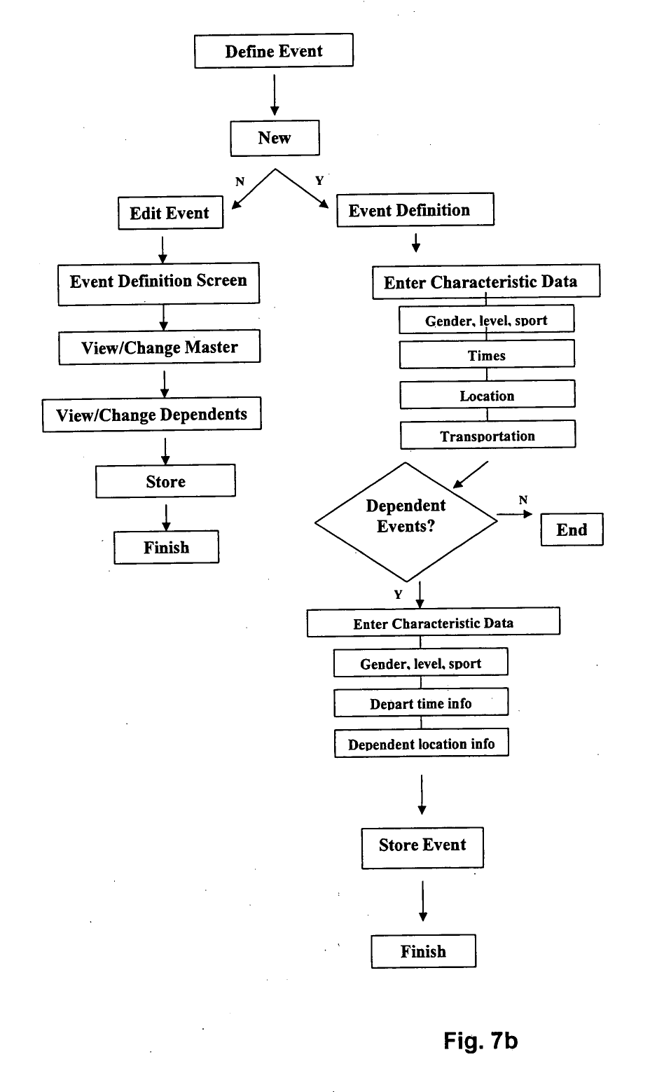

The method of scheduling a sports event is shown further in FIG. 7a. A user can define participants based on their participation on sports teams. In the definition of participants factors such as eligibility can be established. In the present invention, a view (not shown) can be established showing participant eligibility status. Other data defining participants includes position, height, weight, grade, physical exam date and jersey number.

Participants are added to teams. While viewing data, a user can pull up a list of possible participants who can be added to a team. In addition, the system can also copy a team from one year/season to another.

With continuing references to FIG. 7a, once events and teams have been defined, a user can create a scheduled event. A user can schedule teams based on events. Ordinarily, a user will schedule a master event first. A user is shown an interactive screen for entering the information for defining a scheduled event.

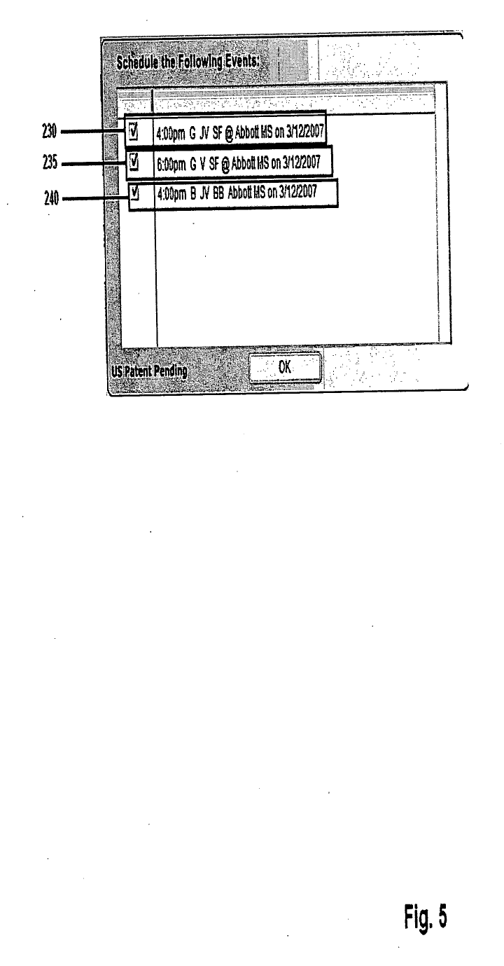

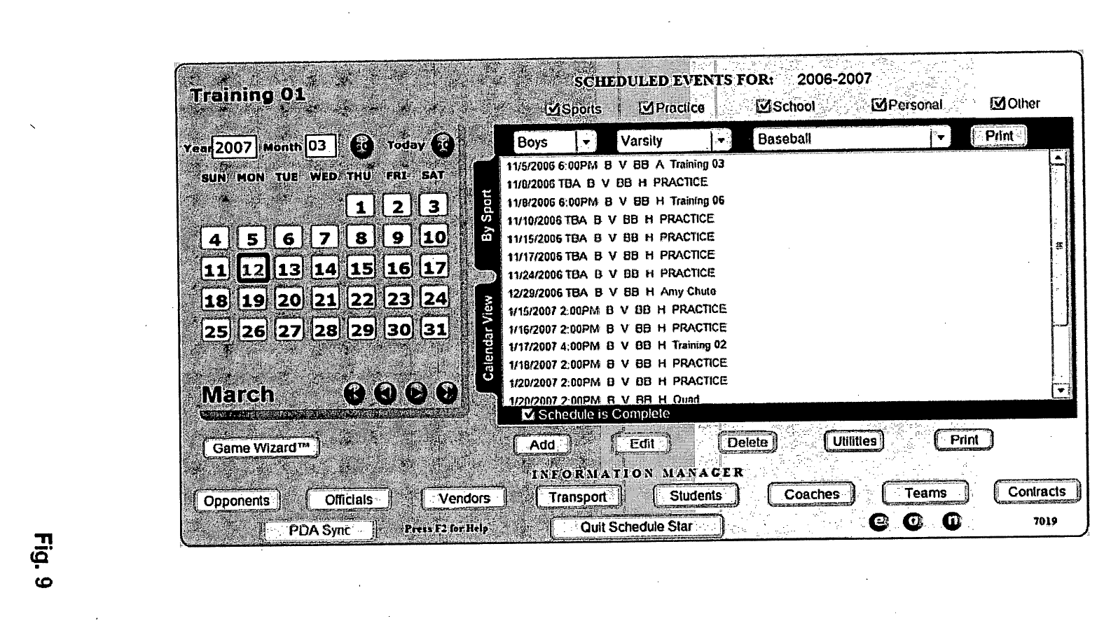

Once the user completes the schedule, the user is given the option of entering dependent events into the system. If the type of event that the user is entering has relationships, a user is shown a screen with dependent events to select for scheduling; these are the events which are dependent for the scheduled sports event. FIG. 5 shows a screen displaying events which are dependent to the master event. The user can select or the dependent events. If the user selects the dependent event, the rules must be met for the event to be accepted and stored. Therefore, there can not be any field, time, player or any other conflicts. If a dependent event is accepted, it is written to a database. A scheduled event can be viewed. FIG. 9 shows a screen for a calendar view of scheduled events. Automatic notification is also possible if a field is set in the DBMS 170. In the present invention, a view of scheduled events is transmitted to a user.

If the dependent events conflict because, for example, another event is scheduled on the same location, then the user can postpone, delay or cancel the event by rescheduling the event. The conflict can be for any rule that is needed for sports events.

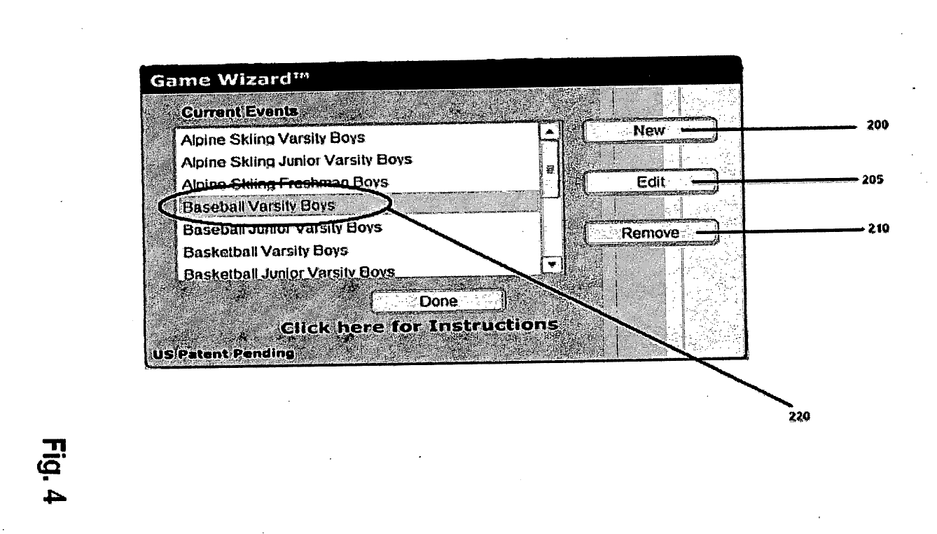

FIG. 7b is a flow diagram presenting the steps for definition of events. A user can either enter events or edit existing events. FIG. 4 shows a screen of the present invention for entering or editing events. A list of events is displayed in the correct events box. If the user is editing, the user can select an event, as shown, Baseball Varsity Boys 220. Then, the user selects edit 205. Otherwise, to create a new event, the user chooses new 200. The user can also remove 210 events, in either case, a user can use an event definition screen as shown in FIG. 3 and discussed later. When the user chooses to enter a new event, the user is prompted to enter the data fields that comprise an event. First, the characteristic information is entered, and it classifies the event, it comprises gender, level and sport. Gender for the sport event is the participant's gender, male or female. The level can be freshman, varsity, junior varsity or others; this is defined by the user. Further characteristic information includes the time, location and transportation. These are the times and locations that are the default for this type of event when the event is scheduled. These times are also the basis for scheduling dependent events as will be shown.

Once characteristic information for an event is entered, a user can choose to make this an automatic event master. A master event is important because it allows a user to define other events which generate automatically when the user is creating the master event, which is conditioned to the master event. The dependent events have characteristic data, but for their time and location they are conditioned off of the master.

For the purpose of example, baseball games present a scenario for showing the automatic scheduling of the present invention, i.e., every time a varsity baseball game is scheduled, a number of other games must be scheduled including freshman, junior varsity baseball, freshmen softball, junior varsity softball and varsity softball. As in most other high school sports, in baseball there is one master and numerous sub-master level sports or departments. Here, varsity baseball is the master event and the others are dependent events.

Events scheduler 101 prompts users to enter or edit event definitions 175. In either case, events scheduler 101 sends a prompt to the user to indicate to events scheduler 101 whether or not to enter or edit an event definition 175. If the user sends an indication to events scheduler 101 to start a new event definition, then events scheduler 101 further provides an interactive template for entering the events definition 175 information. If the user sends an indication to events scheduler 101 to edit an event definition, events scheduler 101 retrieves the event definition 175 from athletic events database 104, which is equal to the scheduled event 165 chosen by the user. A current event 160 is a database record comprising fields of information enumerating event definitions 175. As previously stated, events scheduler 101 interacts with the user through interactive templates which give the user an opportunity to add or edit current events 160 as described above. A preferred embodiment of an interactive web page useful for tracking current events information is shown in FIG. 4.

In the baseball example, the user indicates to events scheduler 101 to add a new event definition 175. Event scheduler sends an interactive template to the user with fields for defining an event definition 175. Boys Varsity Baseball is a master sport and is, therefore, the first event definition 175 created. Event scheduler 101 prompts for all of the characteristic information of the event definition record 175, which are defining characteristics of a boys baseball game. The user would define the characteristics of a home game, including start time, away time and dismiss times, as well as the defining characteristics of an away game. With reference to FIG. 3b, event definition screen 176 prompts for gender 181, level 182 and sport 183 are selected. Next, in the case that the event is a home game, a home facility 184 and transportation 186, if needed, are entered. Times 185 for the game and transportation are entered.

Likewise, in case the game is away, away facility 187 is entered and transportation 189 is entered. Times 188 are entered for both the game and transportation to the game. In short, event definition 175 characteristic information fields include, but are not limited to, the gender, class level, sport, home facility, start time for home games, end time for home games, dismiss time for home games, transportation for home games, away facility, start time for away games, end time for away games, dismiss time for away games and transportation for away games. Important to the events definition are its fields for determining whether an additional game for another team is to be scheduled in correspondence to the particular event.

Varsity baseball is a master sport, and therefore, the event scheduler 101 provides the user interactive fields to add additional dependent level games to varsity baseball teams event definition. The user would define the characteristics of a home game, including start time, away time and dismiss times, as well as the defining characteristics of an away game in the same way as described previously. However, since it is a master event, in varsity baseball there may be many dependent events. For example, the freshman baseball team needs to be added to the definition for varsity baseball.

Boys Freshman Baseball will be scheduled when a varsity baseball game is scheduled. For this example, whenever a varsity baseball game is scheduled, either home or away, a freshman baseball game should be scheduled at the opposite place. Referring to FIG. 3b, a user clicks add 190-1 then either “home or away” should be selected in interactive fields 180 to schedule the following games. This selection indicates to the event scheduler 101 that a game is going to be scheduled each time a varsity baseball game is scheduled, either home or away. Next, the event definition 175 fields for gender 194, level 196, sport 198 and event time 195 should be selected. This information is to be later transmitted with the team information to the event scheduler 101. These fields indicate to the event scheduler 101 which team is to be scheduled, when and where along with varsity baseball, for this example, freshmen baseball. The interactive field for event time 195 has the option to define the game for the same day, the previous day or the next day depending on the standard in that school.

Next, for location, freshmen baseball always plays opposite the varsity team. Therefore, when the varsity team is home, the freshmen team is away and if the varsity team is away the freshmen baseball team plays at home. In some situations, scheduling could be different. For example, in defining the event for a junior varsity baseball team, whenever a junior varsity game is to be scheduled, it is scheduled immediately prior to a varsity game at the same field. Event definition 175 notifies event scheduler 101 through the opposite place interactive field 179. This opposite place 179 determines whether the team of dependent event is opposite the scheduled event. In the case of boys freshman baseball, the opposite place interactive field 179 would be set since the freshman team is going to play on the opposite field as the varsity boys baseball team. A user selects the opposite place interactive field 179 for freshmen baseball. Now the user is ready to transmit the athletic interactive web page 103 from personal computing device 105 to event scheduler 101 to notify of the additional team games to be scheduled at the same time as the independent game.

The event scheduler 101 can be notified of the status of the event in regards to tournament classification 270. If the event scheduler is notified that the game is part of a tournament, then the schedule is adjusted accordingly.

With continuing reference to FIG. 3b, the user now indicates to the event scheduler to add the fields to event definition 175 by clicking on save 190-2, or cancel 190-3. Event scheduler 101 initiates a save template, which sends a verification interactive web page to the user with a view of the game to be scheduled in the games to be scheduled window 192. Once finished, a list of dependent events is displayed in games to be scheduled 192. A user can edit 190-5 or remove 190-5 any dependent event. This will break the reference between the dependent and master. The reference is stored in the database management system 170.

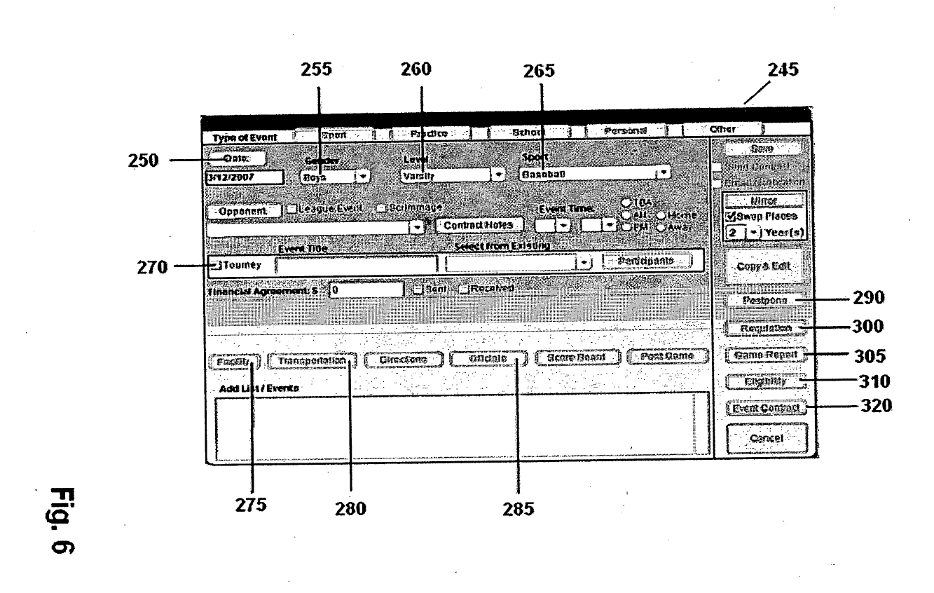

In order to schedule a game, the user must form an instance of an earlier defined event. With reference to FIG. 6, interactive page schedule 245 is used in order to schedule an event; a user first chooses a date 250 on which the event is to take place. Next, characteristic information gender 255, level 260 and sport 265 are selected. If the event is a tourney 270, the event information can be captured. The invention gives further capability for postponing 290. Scheduling facilities 275, transportation 280 and officials 285 are each functions of the schedule. For this, a list of the available entities is given for selection. Another set of functions allows a user to requisition 300, transportation 280, if needed, for the scheduled event. Also, a user can view game report 305 or print it, as well as eligibility reports 310 and event contracts 320.

Scheduled events 165 stores the fields that make up the scheduled games of the Database Management System 170. Event scheduler 101 prompts the user for additional games through the interactive web pages 103; it allows the addition of new scheduled games. With continued reference to the example of boys baseball, the event scheduler 101 prompts the user to enter all of the relevant information pertaining to the schedule for boys varsity baseball game. Once finished, the user notifies the event scheduler 101 of completion through an athletic interactive web page 103. The event scheduler, in turn, prompts the user for additional selection of dependent sports. Event scheduler 101 would prompt the user to schedule additional teams, depending on which teams have been defined to correspond to the master event. For example, in baseball, boys junior varsity baseball, boys freshman baseball, girls freshman softball, girls junior varsity softball and girls varsity softball may all have been entered as a dependent of boys varsity baseball, in which case event scheduler 101 would attempt to place them all on the schedule.

Shown in FIG. 5, a preferred embodiment of an interactive web page useful for prompting for information about the dependent event Boys Freshmen Baseball schedule by the event scheduler 101. The method of the present invention can automatically assign dependent events, but if the user chooses to be prompted, a box as in FIG. 5 can be used. Along with the name of the team, time and date information is listed with interactive check box to prompt the user to notify event scheduler 101 whether to schedule the dependent event. As shown, events are shown to be ready for scheduling. Girls JV Softball 230, Girls Varsity Softball 235 and Boys JV Baseball 240 are all events which depend on the master event of Men's Varsity Baseball. Once the event scheduler 101 is notified to schedule the dependent event, the event is scheduled and the event scheduler 101 continues to prompt the user for any other dependent events of the newly scheduled master event.

When the Boys Varsity Baseball game is added, events scheduler 101 next determines if the user has indicated that a game is to be scheduled and prompts the user to schedule additional dependent level events. The user can notify the event scheduler 101 by the use of interactive web pages of any games that do not need to be scheduled.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

The invention claimed is:

1. A method to schedule events, the method comprising:
creating a master event and at least one other event and assigning said other event to the master event, said other event being dependent for scheduling upon when the master event is scheduled, said assignment being adapted to rules for specific restrictions;
scheduling the master event for a facility;
scheduling a dependent event by saving a data field describing a schedule; and
transmitting a view to a user showing an event scheduled for a particular date.

2. The method of claim 1, wherein the act of scheduling the master event for a facility includes at least one of the following acts:
tracking information associated with a participant;
creating at least one team comprising participants;
assigning transportation;
mirroring an event for any number of years for scheduling in subsequent years of a series of events;
postponing an event either by delaying or canceling;
assigning officials for an event;
printing a requisition request for transportation;
checking eligibility of participants;
printing an event contract;
printing an event schedule; and
printing participant certificates.

3. The method of claim 1, wherein the act of creating a master event includes at least one of the following acts:
creating a database comprising data records for said other event and said master event; and
assigning a data field referencing the other event to the master event.

4. The method of claim 1, wherein the act of entering an event includes at least one of the following acts:
entering event gender, level and sport for matching said other event to the master event; and
entering event characteristic information for completing an event record.

5. The method of claim 4, wherein the characteristic information includes at least one of the following:
home facility;
start time;
end time;
dismiss time;
transportation; and
away facility.

6. The method of claim 1, wherein the act of creating at least one team includes at least one of the following:
a coach;
an assistant coach;
a manager; and
a player;

7. The method of claim 1, wherein the rules for specific restrictions includes at least one of the following:
schedule said other event when the master event is home;
schedule said other event when the master event is away;
schedule said other event when the master event is home or away;
schedule said other event home when the master event is away;
schedule said other event away when the master event is home; and
schedule the event time and day.

8. The method of claim 1, wherein the act of transmitting a view to a user showing the events scheduled for a particular date includes:
generating a link to an interactive web page; and
generating an electronic mail message for viewing events scheduled, including a calendar.

9. The method of claim 8, wherein the act of transmitting a view to a user showing the events scheduled for a particular date includes:
said calendar having selectable dates whereby clicking on said selectable date further displays scheduled events corresponding to a said selectable date.

10. The method of claim 1, further including the step of indicating a dependent event which is to be scheduled at a facility and other facilities for a scheduled date.

11. An automated events scheduling system comprising:
a database for storing athletic events information and at least one event definition that associates a particular athletic event with at least one parent event;
an events scheduler capable of electronically receiving new event information submitted by a user, producing a plurality of athletic interactive web pages using event information contained in said database, and automatically, electronically transmitting said athletic interactive web pages to users associated with said athletic event as determined by said database;
said events scheduler further comprising access means operably coupled to said database for accessing contents of said database; and
at least one personal computing device associated with a user and operably coupled to said events scheduler via an electronic network for transmitting and receiving an electronic message including said new athletic event information and said athletic interactive web pages.

12. An automated events scheduling system comprising:
a database for storing athletic events information and at least one event definition that associates a particular athletic event with at least one parent event;
an events scheduler capable of electronically receiving new athletic event information submitted by a user, producing a plurality of athletic event web pages using athletic event information contained in said database, and automatically, electronically transmitting said athletic interactive web pages to users associated with said athletic organization associated with said new athletic event as determined by said database;
said events scheduler further comprising an application engine for providing access to said database, said application engine operably coupled to said database for accessing contents of said database in accordance with instructions specified in a plurality of scripts;
a plurality of personal computing devices, each said device being associated with one of said users, and operably coupled to said events scheduler via an electronic network for transmitting and receiving electronic messages, including said new athletic event information and said athletic interactive web pages;
said events scheduler automatically transmitting said new event athletic interactive web pages to a plurality of event addresses comprising users associated with said organization associated with said new event as determined by said database; and
said events scheduler producing and transmitting said user requested athletic interactive web pages to said personal computing devices using an electronic network in response to a user request received via said personal computing device.
